(19) United States
(12) Patent Application Publication
(10) Pub. No.: US 2006/0090963 A1
(43) Pub. Date: May 4, 2006

(54) High-rise emergency escape device

(76) Inventor: Yin-Hsi Liao, Taipei Hsien (TW)

Correspondence Address: RABIN & Berdo, PC, 1101 14TH STREET, NW, SUITE 500, WASHINGTON, DC, 20005, US

(21) Appl. No.: 10/974,761

(22) Filed: Oct. 28, 2004

(51) Int. Cl. A62B 1/20

(52) U.S. Cl. 182/193

(57) ABSTRACT

A high-rise escape device includes a handgrip forming a first channel, and a handle pivoted to the handgrip and rotatable with respect to the handgrip between a locked position and a released position. The handle forming a second channel, which forms, together with the first open channel, a gap having a predetermined size to define a passage for the rope with a predetermined friction induced between the channels and the rope when the handle is at the locked position. An emergency escape system includes a rope extending from a high-rise building to the ground with a buffering member slidably fit over the rope. The escape device is coupled to the rope by pinching the rope between the first and second channels. A belt surrounds and secures a user to the escape device, whereby the user is allowed to slide down along the rope with a controlled speed for safely reaching the ground.

### BACKGROUND OF THE INVENTION

1. Field of the Invention

The present invention relates generally to an emergency escape device for high-rise buildings.

2. Prior Arts

Emergency escape device is one the most important apparatus that a high-rise building must equip. It allows users to escape out of the high-rise building and reach ground safely in case of emergency, such as earthquake and fire catastrophe. However, it is criticized as the complicated structure and operation though the conventional device may effectively rescue people from the high-rise building.

### SUMMARY OF THE PRESENT INVENTION

An objective of the present invention is to provide an emergency escape device having simplified structure and minimal training ready to operate.

Another objective of the present invention is to provide an emergency escape device that allows people to be conveyed from a high-rise building down to the ground with controlled speed so as to enhance operation safety.

A further objective of the present invention is to provide an emergency escape device that allows a user to set a predetermined friction between the device and a rope along which the user is to slide down from a substantial height down to the ground in advance whereby the sliding speed of the escape device can be immediately set in an emergency situation.

A further objective of the present invention is to provide an emergency escape device, which allows the user to manually control the sliding speed by hand moving a movable part with respect to a stationary part during the process of sliding down along a rope.

A further objective of the present invention is to provide an emergency escape device, which allows for a preset sliding movement of the emergency escape device along a rope and also an adjustment of the sliding movement during the process of sliding.

Yet a further objective of the present invention is to provide an emergency escape device that comprises a ready-to-release locking device, allowing the user to readily release and/or couple the escape device from/to a rope along which the user may slide down from a high-rise building for rescue.

A further objective of the present invention is to provide an emergency escape system comprising a rope connecting between a high-rise building and the ground with a buffering device sliding fit over the rope and an escape device as described to cooperate with and slide down along the rope for high-rise emergency rescues.

### BRIEF DESCRIPTION OF THE DRAWINGS

FIG. 1 is an exploded view of an escape device constructed in accordance with the present invention;

FIG. 2 is a perspective view of the escape device in a released condition;

FIG. 3 is a perspective view of the escape device in a locked condition, together with a belt that secures a person attached to the escape device;

FIG. 4 is a bottom view of the escape device in the locked condition;

FIG. 5 is a side elevational view of the escape device in the locked condition;

FIG. 6 is an exploded view of a locking device for securing the escape device in the locked condition;

FIG. 7 is a side elevational view of the locking device;

FIG. 8 is a schematic view demonstrating coupling of the belt that secures a person to the escape device with a buckle; and

FIG. 9 is a schematic view illustrating a high-rise emergency escape system incorporating the escape device of the present invention.

### DETAILED DESCRIPTION OF THE PREFERRED EMBODIMENT

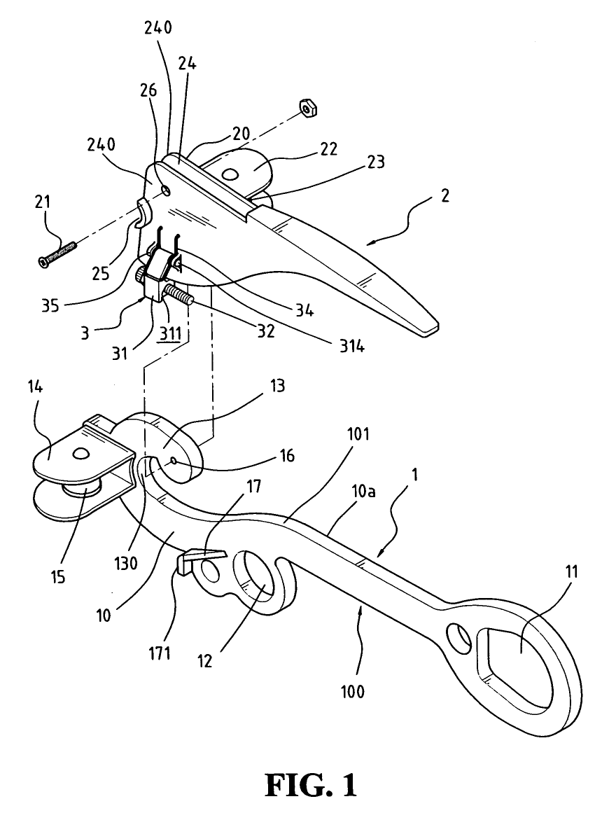

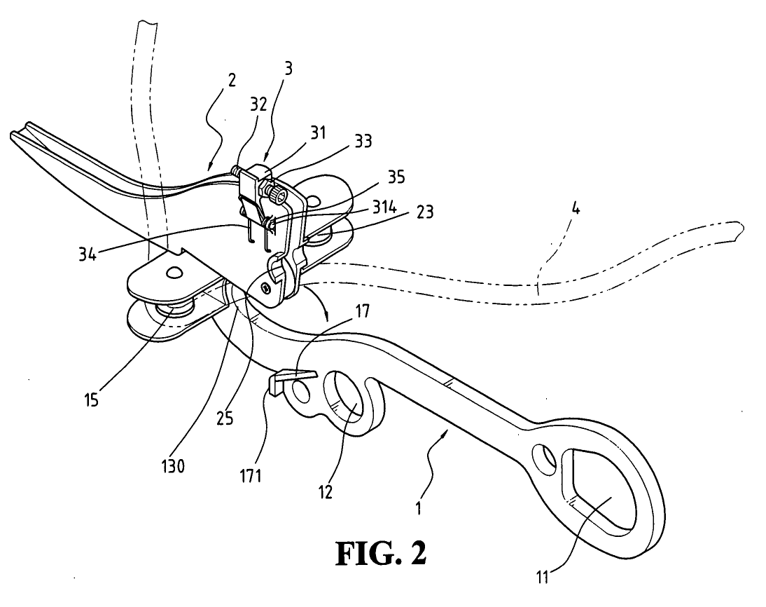

With reference to the drawings and in particular to FIGS. 1-5, a high-rise emergency escape device constructed in accordance with the present invention comprises a stationary handgrip 1 and a movable handle 2 pivoted to the handgrip 1 by a pivot 21 whereby the a gripping gap through which a rope 4 extends is adjustable by rotation of the movable handle 2 with respect to the handgrip 1 to control friction between the escape device and the rope 4 and thus controlling the speed of a person carried by the escape device sliding down along a rope 4.

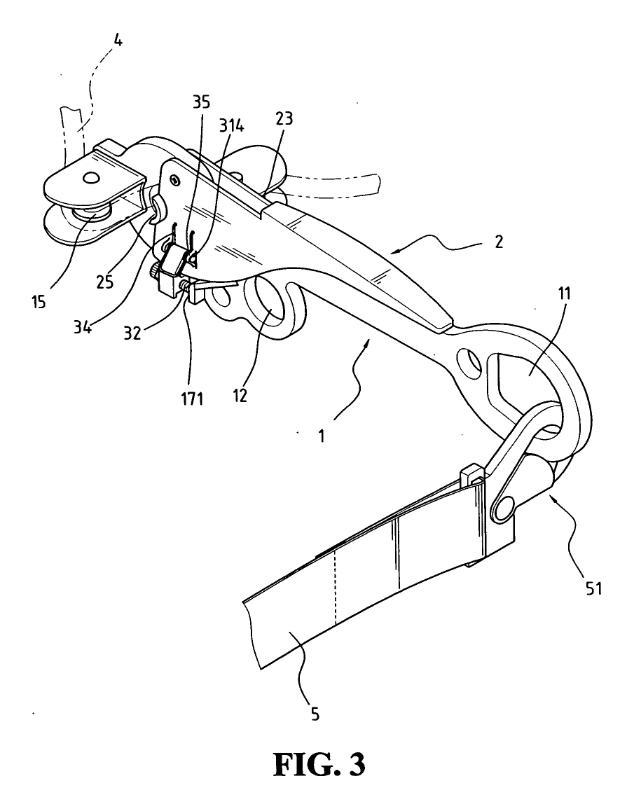

The stationary handgrip 1 comprises a flat elongate body 100 having a first end forming a J-shaped hook 13 defining a rope channel 130 and an opposite second end forming a buckle hole 11 with which a buckle 51 (see FIG. 3) may engage. A finger opening 12 is defined at one longitudinal edge of the elongate body 100 for the extension of a user's finger (not shown) in holding the escape device.

The flat body 100 has opposite first and second major faces 10, 10a. A first pulley 15 is mounted to the first face 10 of the handgrip 1 at a position closed to the hook 13 so that the first pulley 15 substantially aligns with the rope channel 130 for smoothly guiding the rope 4 into the rope channel 130. In the embodiment illustrated, the first pulley 15 is fixed to the handgrip 1 by a first pulley holder 14, which comprises a lying-down U-shaped member having two spaced limbs connected by a bottom. The bottom is fixed to the first major face 10 of the handgrip 1 by any suitable means, such as bolts, rivet, and welding. The first pulley 15 is rotatably supported between the limbs of the U-shape of the first pulley holder 14. Preferably, the rotational axis of the first pulley 15 is substantially parallel to the first major face 10 of the handgrip body 100.

A through hole 16 is defined in an end portion of the J-shaped hook 13 for the extension of the pivot 21.

The movable handle 2 comprises two spaced plates 240 defining an interior space 24 therebetween, which rotatably receives therein the thickness 101 of the handgrip 1, which is the dimension between the major faces 10, 10a of the handgrip 1. In other words, when the handgrip 1 is received in the movable handle 2, the major faces 10, 10a of the handgrip 1 are in surface contact with inner surfaces of the plates 240 of the handle 2, yet with a certain clearance therebetween to allow for rotation of the handle 2 with respect to the handgrip 1. Aligned through holes 26 are defined in the plates 240 closed to a first end of the handle 2 for the extension of the pivot 21. The pivot 21 thus extends through both the through holes 26 of the handle 2 and the through hole 16 of the handgrip 1 to pivot the first end of the handle 2 to the first end of the handgrip 1, which leaves an opposite end of the handle 2 rotatable between locked and released positions, which will be further described

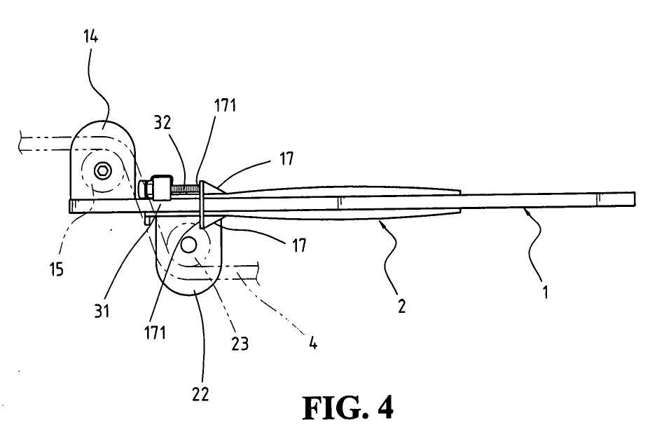

On an outer surface 20 of one of the plates 240 of the handle 2, a second pulley 23 is fixed whereby the second pulley 23 and the first pulley 15 are located on opposite sides of the escape device. The second pulley 23 is fixed to the plate 240 by a second pulley holder 22, which, similar to the first pulley holder 14, has a U-shaped configuration with a bottom fixed to the plate 240 by suitable means, such as bolt, rivet, and welding and two limbs rotatably supporting the second pulley 23 therebetween. The second pulley 23 is provided to guide the rope 4 out of the rope channel 130. Preferably, the first and second pulley 15, 23 are arranged to guide the rope 4 through the escape device in an S-shape as particularly shown in FIG. 4.

A concave recess 25 is defined in the first end of plates 240 of the handle 2 to function as a guide channel for the rope 4. The guide channel 25 corresponds in position to the rope channel 130 of the hook 13 of the handgrip body 10. The guide channel 25 and the rope channel 130 cooperate with each other to form a passage for the rope 4. Due to the rotatability of the handle 2 with respect to the handgrip 1, the relative position of the guide channel 25 with respect to the rope channel 130 is changeable, which leads to adjustability of the cross-sectional dimension of the rope passage. In other words, the rope 4 may be subject to different magnitude of gripping force applied thereto by the rope channel 130 and the guide channel 25, rendering different friction between the rope 4 and the escape device. This allows a user to control sliding speed along the rope 4, which will be further described.

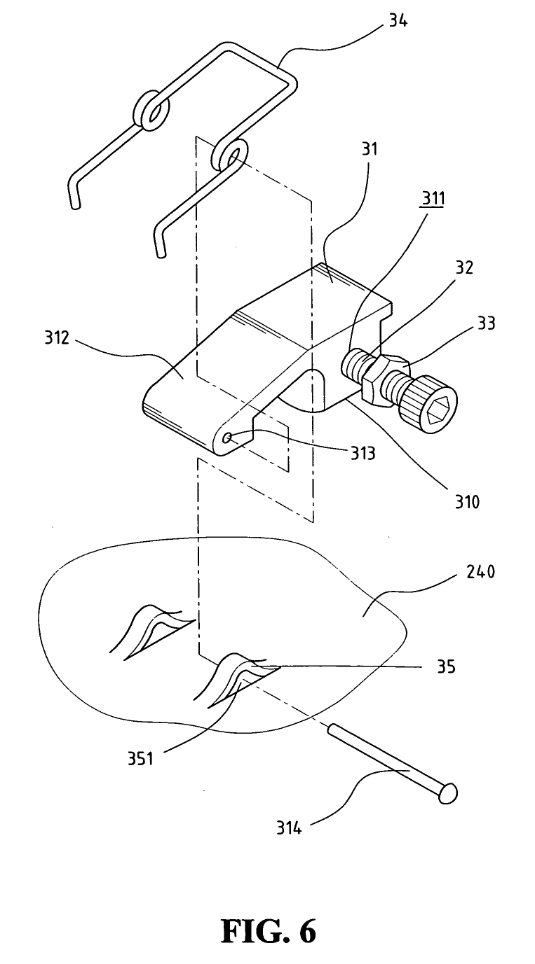

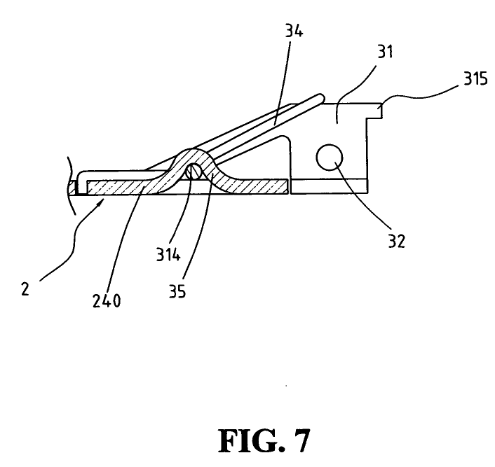

Also referring to FIGS. 6 and 7, a locking device is provided to secure the handle 2 at a predetermined position (the locked position) with respect to the handgrip 1, which means a fixed spatial relationship between the rope channel 130 and the guide channel 25 and thus a fixed friction and sliding speed between the escape device and the rope 4. The locking device comprises a movable body 31 that is movably attached to one of the plates 240 of the handle 2 and an adjustable pin 32 extending from the movable body 31. The locking device further comprises a locking tab 171 fixed to the major face 10 of the handgrip body 100. The pin 32 has a free end engageable with the locking tab 171, which secures the handle 2 in the locked position with respect to the handgrip 1. In other words, the handle 2 is prevented from moving away from the handgrip 1 (moving from the locked position to the released position) when the pin 32 engages the locking tab 171, thereby ensuring a predetermined friction between the escape device and the rope 4.

Spaced protrusions 35 are formed on one plate 240 of the handle 2. Aligned holes 351 are defined in the protrusions 35. The movable body 31 of the locking device comprises an arm 312 having a free end in which a through hole 313 is defined. A pivot pin 314 extends through both the holes 351 and the hole 313 to rotatably mount the main body 31 to the plate 240 of the handle 2. A resilient biasing member 34, such as a spring illustrated in the drawings, is arranged between the movable body 31 and the handle 2 to secure the movable body 31 at an engaging position, while, under the action of a counter force, allowing the movable body 31 to move from the engaging position to a disengaging position. In the embodiment illustrated, the spring 34 has a U-shaped having two limbs each forming a helical portion fit over the pivot pin 314 and a bottom supported on the movable body. Ends of the limbs engage the handle 2 to bias the movable body 31 to the engaging position where the movable body 31 abuts against the handle 2 with the pin 32 engaging the locking tab 171. By forcibly rotating the main body 31 about the pivot pin 314 in a direction away from the handle 2 and against the spring 34, the pin 32 is brought away from the locking tab 171 and engagement therebetween is broken to release the handle 2. This allows the escape device to be removed from the rope 4 or to readjust the friction between the escape device and the rope 4.

In the embodiment illustrated, the locking pin 32 comprises a threaded section that engages an inner-threaded hole 311 defined in the movable body 31. The threading engagement between the pin 32 and the hole 311 allows for adjustment of the relative position of the pin 32 with respect to the main body 31 and thus adjustment of the predetermined locked position of the handle 2 with respect to the handgrip 1, which in turn allows for adjustment of the friction between the escape device and the rope 4.

A nut 33 is selectively mounted in the threaded section of the pin 32. The nut 33 is abuttingly engageable with the main body 31 to prevent undesired movement of the pin 32 with respect to the main body 31 thereby securing the relative position of the pin 32 and thus the friction between the escape device and the rope 4.

A guide plate 17, functioning as a camming surface, is mounted to the handgrip 1 adjacent to the locking tab 171. The movable body 31 of the locking device is provided with a camming portion 310, which, when the movable body 31 is moved from the disengaging position back into the engaging position, is engageable with the guide plate 17 under the action of the biasing force of the spring 34. The guide plate 17 guides the movable body 31 back into the engaging position by camming engagement between the guide plate 17 and the camming portion 310.

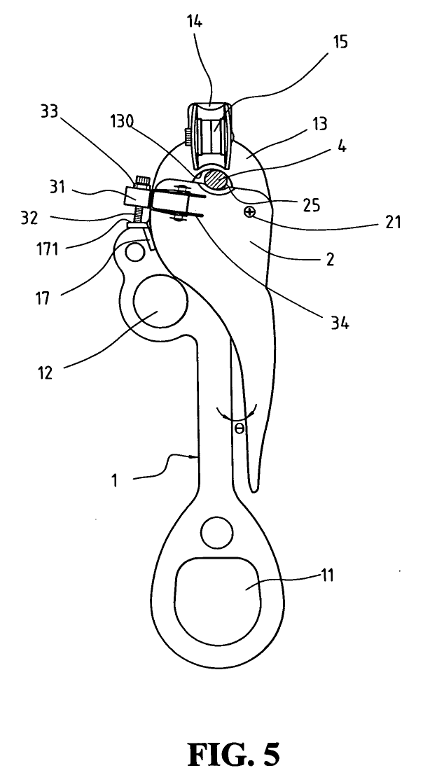

It is noted that as best seen in FIG. 5, a gap defined by an angle θ is present between the handle 2 and the handgrip 1 when the handle 2 is secured at the locked position by the locking device. Such a gap allows a user to manually and forcibly grip the rope 4 between the rope channel 130 of the handgrip 1 and the guide channel 25 of the handle 2. Thus, the friction between the escape device and the rope 4 can be selectively adjusted by the hand holding force of the user.

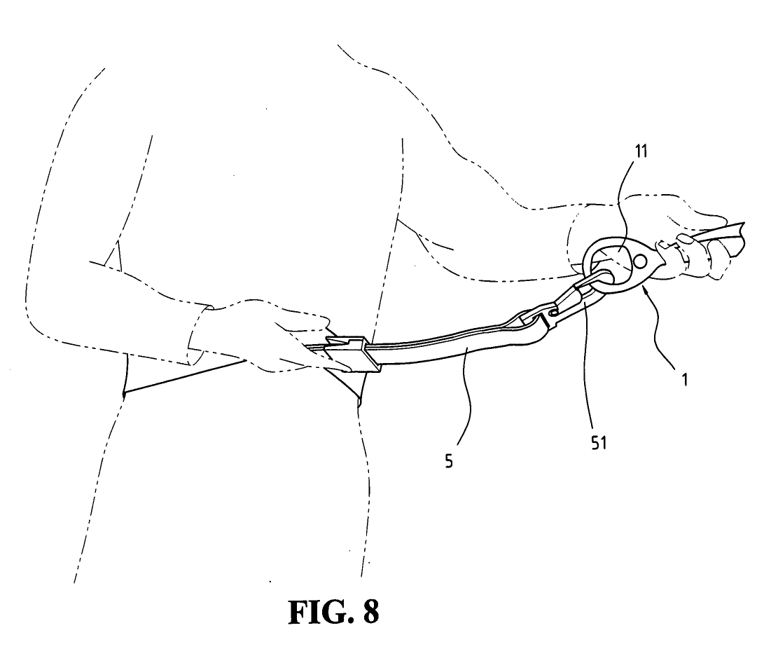

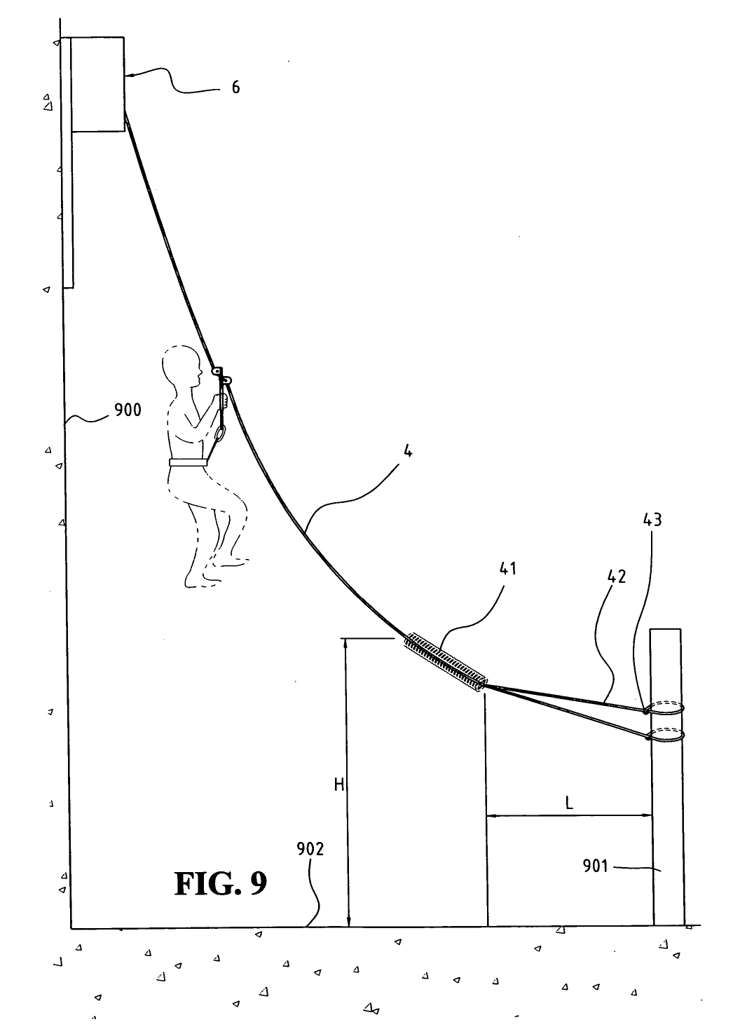

Also referring to FIGS. 8 and 9, a high-rise emergency escape system in accordance with the present invention comprises a rope 4 extending from an emergency escape facility 6 mounted to a high-rise building 900 down to a column 901 fixed to the ground 902 at a distance from the building 900. Two branch ropes 42 extend from the free end of the main rope 4 and are tightened to the column 901 at different altitudes by for example hooks 43. A buffering member 41, such as a spring, a foamed body, and a rubber block, is slidably fit over the main rope 4 and is maintained in position by the branches 42. Preferably, a predetermined distance L is present between the buffering member 41 and the column 901 and a predetermined height H is present between the buffering member 41 and the ground 902.

To operate, the user wraps and secures a belt 5 around his or her waist and couples a buckle 51 fixed at an end of the belt 5 to the buckle hole 11 of the handgrip 1. The user may then open the movable handle 2 of the escape device of the present invention by releasing the locking device, position the rope 4 in the rope channel 130 of the handgrip 1, and close and lock the handle 2 whereby the rope 4 is pinched between the handle 2 and the handgrip 1. The user holds the handgrip 1 and selectively adjusts the friction between the escape device and the rope 4 and then slide down along the rope 4.

Once the user approaches the column 901, the buffering member 41 effectively decelerates the user and protects the user from directly colliding the column 901 and the falling onto the ground 902. The distance L and the height H ensure that the user does not hit the column 901 or the ground 902. Once reaching the ground 902, the user may open the handle 2 and release the escape device from the rope 4 to allow the next user to safely slide down along the rope 4.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An escape device adapted to slide down along a rope, the escape device comprising:
a handgrip having a first end and an opposite second end, the second end being adapted to carry a user, the first end forming a first open channel; and
a handle having a first end pivoted to the first end of the handgrip and an opposite second rotatable with respect to the handgrip between a locked position and a released position, the handle forming a second open channel which forms, together with the first open channel, a gap having a predetermined size to define a passage for the rope with a predetermined friction induced between the channels and the rope when the handle is at the locked position.

2. The escape device as claimed in claim 1, wherein a gap is present between the handle and the handgrip when the handle is at the locked position, the gap allowing for further movement of the handle with respect to the handgrip to further reduce the gap between the first and second channel so as to increase the friction between the channels and the rope.

3. The escape device as claimed in claim 1 further comprising a locking device comprising a pin mounted to the handle with a free end of the pin engaging a locking tab fixed on the handgrip to secure the gap between the first and second channels, the pin being movable with respect to the handle for adjusting the size of the gap between the channels.

4. The escape device as claimed in claim 3, wherein the locking device defines an inner-threaded hole, and wherein the pin comprises a threaded section engaging the inner-threaded hole for movement with respect to the handle.

5. The escape device as claimed in claim 4, wherein the locking device further comprises a nut selectively securing the pin at the first position.

6. The escape device as claimed in claim 4, wherein the locking device comprises a body rotatably mounted to the handle and movable between a first position where the pin engages the locking tab to secure the handle at the locked position and a second position where the pin disengages from the locking tab to release the handle from the locked position.

7. The escape device as claimed in claim 6, wherein the body is biased toward the first position by a biasing member.

8. The escape device as claimed in claim 7, wherein the biasing member comprises a spring arranged between the body and the handle.

9. The escape device as claimed in claim 8, wherein the locking device comprises a guide plate fixed to the handgrip and forming a camming surface and wherein the body comprises a camming portion engageable with the camming surface for guiding, under the action of the spring, the handle from the released position back to the locked position.

10. The escape device as claimed in claim 1, wherein the first end of the handgrip forms a J-shaped hook defining the first open channel and wherein the first end of the handle forms a recess corresponding in position to the J-shaped hook and defining the second channel.

11. The escape device as claimed in claim 1, wherein the second end of the handgrip forms a bore adapted to engage a buckle formed at an end of a belt retaining the user.

12. The escape device as claimed in claim 1, wherein the handgrip forms a finger hole for the extension gripping of the user's finger.

13. The escape device as claimed in claim 1, wherein the handgrip comprises a flat body rotatably received between two spaced plates of the handle with a pivot pin extending through aligned holes defined in the flat body and the plates.

14. The escape device as claimed in claim 1 further comprising first and second pulleys mounted to opposite sides of the escape device for guiding the rope into and out of the rope passage.

15. The escape device as claimed in claim 14, wherein each pulley is rotatably supported by a U-shaped member fixed to the escape device.
